(19) United States
(12) Patent Application Publication
(10) Pub. No.: US 2024/0320723 A1
(43) Pub. Date: Sep. 26, 2024

(54) CUSTOMER PRODUCT MARKETING PLATFORM

(71) Applicant: Wells Fargo Bank, N.A., San Francisco, CA (US)

(72) Inventors: Jasmine de Gaia, Lewis Center, OH (US); Vijo Varghese, Allen, TX (US)

(21) Appl. No.: 18/188,280

(22) Filed: Mar. 22, 2023

(51) Int. Cl. G06Q 30/0601

(52) U.S. Cl. CPC G06Q 30/0611

(57) ABSTRACT

Techniques are described for creating and maintaining rules to identify customers based on customer traits from customer data and applying the rules to current customer data at a point in time to identify the customer traits in the customer data. A computing system is configured to maintaining one or more rules configured to identify one or more customer traits from customer data, receive customer data of a plurality of customers at a first point of time, apply the one or more rules to the customer data to identify the one or more customer traits in the customer data for one or more customers of the plurality of customers, and outputting a report comprising a plurality of customer identifiers for the plurality of customers and, for a particular customer identifier for a particular customer, one or more indicators of which customer traits are associated with the particular customer.

### TECHNICAL FIELD

This disclosure relates to computer system and, in particular, computer systems that store and analyze customer data.

### BACKGROUND

A component of marketing is identifying customers for an organization's products. Organizations may leverage vast amounts of data, often referred to as “big data”, to identify potential customers for a product. Organizations may leverage “big data” to organize marketing campaigns and maintain lists of potential customers to more efficiently utilize marketing resources.

### SUMMARY

In general, the disclosure describes a computing system configured to create and maintain rules to identify customer traits from customer data, and apply the rules to current customer data of a plurality of customers at a point of time to identify the customer traits in the current customer data. The computing system also generates and outputs reports including customers identifiers for the plurality of customers and, for each particular customer identifier, indicators that align with the customer traits associated with the particular customer.

More specifically, in response to a request to generate a report of customers having certain customer traits for a marketing campaign, the disclosed computing system selects one or more rules created to identify the certain customer trains. The disclosed computing system applies the one or more rules to the current customer data stored in an operational database in order to identify the customers that currently have the certain customer traits. Updates to the customer data, which may be received daily, weekly, continuously, or the like, may cause the customer trait results to change. As such, the computing system may apply the one or more rules to the updated customer data, daily, weekly, or the like, in order to provide updated reports on customer traits for potential use in the marketing campaign.

The disclosed computing system is configured to generate business logic abstracted from code for configuration by marketing teams. The disclosed system may receive configurations of abstracted business logic from user computing devices and process the configured business logic. The disclosed system may receive configured business logic such as user configurations of requirements for selecting customers from one or more databases based on traits of the customers. The disclosed system processes the configured business logic into rules for identifying customers based on the customer traits. The disclosed system then applies the rules to one or more databases to identify customers that meet the required customer traits, and outputs a report of the customers.

The techniques of this disclosure may provide one or more advantages. The ability to generate rules for identifying customers for a marketing campaign from business logic abstracted away from code may enable accelerated execution of marketing campaigns by removing the need for software developers to write code necessary to implement the identification of customers. The ability to implement the identification of customers for a marketing campaign without a software development cycle enables faster responses to changing market conditions and an accelerated conception-to-deployment timeline for marketing campaigns. The disclosed techniques additionally may provide for faster processing of the customer data through parallel processing, waterfall logic, and/or identification of customer data deltas from previous processing of customer data.

In one example, this disclosure is directed to a method comprising maintaining, by a computing system, one or more rules configured to identify one or more customer traits from customer data, receiving, by the computing system, customer data of a plurality of customers at a first point of time, applying, by the computing system, the one or more rules to the customer data to identify the one or more customer traits in the customer data for one or more customers of the plurality of customers, and outputting, by the computing system, a report comprising a plurality of customer identifiers for the plurality of customers and, for a particular customer identifier for a particular customer, one or more indicators of which customer traits are associated with the particular customer.

In another example, this disclosure is directed to a computing system comprising a memory and one or more programmable processors in communication with the memory. The one or more programmable processors are configured to maintain one or more rules configured to identify one or more customer traits from customer data, receive customer data of a plurality of customers at a first point of time, apply the one or more rules to the customer data to identify the one or more customer traits in the customer data for one or more customers of the plurality of customers, and output a report comprising a plurality of customer identifiers for the plurality of customers and, for a particular customer identifier for a particular customer, one or more indicators of which customer traits are associated with the particular customer.

In a further example, this disclosure is directed to a non-transitory computer readable medium comprising instructions that, when executed, cause one or more processors to maintain one or more rules configured to identify one or more customer traits from customer data, receive customer data of a plurality of customers at a first point of time, apply the one or more rules to the customer data to identify the one or more customer traits in the customer data for one or more customers of the plurality of customers, and output a report comprising a plurality of customer identifiers for the plurality of customers and, for a particular customer identifier for a particular customer, one or more indicators of which customer traits are associated with the particular customer.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system including a marketing utility computing platform configured to create, manage, and apply rules configured to identify customer traits from customer data for use in marketing campaigns, in accordance with one or more techniques of this disclosure.

FIG. 2 is a block diagram illustrating an example data analytics system configured to execute the marketing utility computing platform from FIG. 1.

FIG. 3 is a block diagram illustrating an example of the marketing utility computing platform from FIG. 1 in greater detail.

FIG. 4 is a block diagram illustrating an example operation of a marketing utility computing device configured to maintain rules configured to identify customer traits and apply the rules to customer to data to identify customers having the customer traits, in accordance with one or more techniques of this disclosure.

FIG. 5 is a chart illustrating example time durations from determination of business logic for a marketing campaign to implementation of the marketing campaign in different scenarios.

FIG. 6 is a flowchart illustrating an example operation of a marketing utility computing platform, in accordance with one or more techniques of this disclosure.

FIG. 7 is an example user interface of the marketing utility computing platform illustrating the authoring of rules.

FIG. 8 is an example user interface of the marketing utility computing platform illustrating an example output of customer identifiers and associated traits.

### DETAILED DESCRIPTION

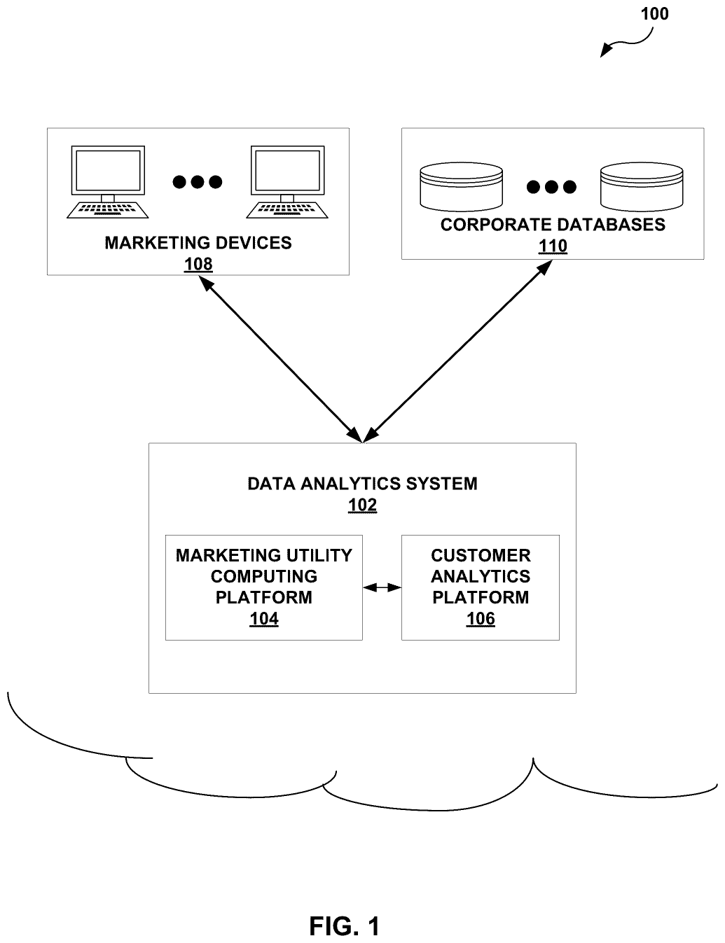

FIG. 1 is a block diagram illustrating an example system 100 including a marketing utility computing platform 104 configured to create, manage, and apply rules configured to identify customer traits from customer data for use in marketing campaigns, in accordance with one or more techniques of this disclosure. As illustrated in FIG. 1, system 100 includes marketing devices 108, corporate databases 110, and data analytics system 102 executing marketing utility computing platform 104 and customer analytics platform 106. Data analytics system 102 may be in communication with marketing devices 108 and corporate databases 110 over one or more private or public networks via one or more protocols or communication channels such as Wi-Fi®, Ethernet, fiber optic, and/or other methods of communication.

Marketing devices 108 may include computers, laptops, tablet computers, thin client devices, and other such computing devices used by data analysts of a corporation or other organization. Marketing devices 108 may communicate with data analytics system 102 to request the generation of reports of customer identifiers. Marketing devices 108 may communicate with data analytics system 102 over a network such as private network within a company or a public network. Marketing devices 108 may additionally communicate with data analytics system 102 to manage the rules used to generate the reports of customer identifiers.

Marketing device 108 may receive user input consistent with a configuring of business logic. Marketing devices 108 may receive user input such as user interaction with a GUI, a user selecting an item from a drop-down menu, a user typing marketing teams and Boolean logic, and the like consistent with the configuring of business logic. Marketing devices 108 may encode the user input into business logic consisting of software representative of the user configurations. Marketing devices 108 may provide the user input data to data analytics system 102.

Corporate databases 110 may include a plurality of databases. Corporate databases 110 may include a plurality of local databases, data center storage nodes, public or private cloud storage systems, systems of record (SoRs), and other storage facilities in which large data sets are stored. Corporate databases 110 may store corporate data on one or more storage mediums such as hard disk drives, solid state storage, and tape storage. Corporate databases 110 may store corporate data such as customer data (e.g., data on mortgages, customer financial statistics, and other customer data).

Data analytics system 102 may provide a variety of data analysis processes accessible by marketing devices 108. Although illustrated in FIG. 1 as including a single device executing a single marketing utility computing platform 104 and a single customer analytics platform 106, data analytics system 102 may comprise a centralized or distributed system of computing devices, such as desktop computers, laptops, workstations, wireless devices, cloud-based compute nodes, network-ready appliances, file servers, print servers, or other devices, configured to execute and/or support one or more instances of marketing utility computing platform 104 and customer analytics platform 106.

In the example of FIG. 0.1, data analytics system 102 executes customer analytics platform 106. Customer analytics platform 106 may provide users, such as the users of marketing devices 108, with a unified exploratory environment to access and analyze data. Customer analytics platform 106 may manage the feeding and preprocessing of data into marketing utility computing platform 104. For example, customer analytics platform 106 may manage how frequently data is provided to marketing utility computing platform 104 and preprocess the data received from corporate databases 110.

In the example of FIG. 1, data analytics system 102 executes marketing utility computing platform 104. Marketing utility computing platform 104 may include one or more software components executing on one or more computing devices within data analytics system 102. Marketing utility computing platform 104 may include a rules base that stores a plurality of rules used to identify customer traits in customer data. Marketing utility computing platform 104 may store rules that identify one or more customer traits such as credit score, location, net worth, whether a customer has a mortgage in good standing, and current credit card usage among other traits.

Marketing utility computing platform 104 may obtain customer data from one or more sources such as corporate databases 110 and customer analytics platform 106 to process customer data using rules for certain marketing campaigns to identify applicable customers. Marketing utility computing platform 104 may obtain customer data that is organized by customer identifiers. Customer analytics platform 106 may organize and pre-process customer data before providing the customer data to marketing utility computing platform 104. In an example, marketing utility computing platform 104 requests customer mortgage data from corporate databases 110. Data analytics server 102 may obtain the customer mortgage data from corporate databases 110, however the customer mortgage data may not be organized by the customer identifiers used by marketing utility computing platform 104. Customer analytics platform 106, responsive to determining that the data is not organized for use by marketing utility computing platform 104, preprocesses the data to organize it for marketing utility computing platform 104.

Marketing utility computing platform 104 may enable users of marketing utility computing platform 104 such as marketing devices 108 to configure business logic that is an abstraction of rules used to implement a marketing campaign. Marketing utility computing platform 104 may generate data representative of a user interface, such as a graphical user interface (GUI), for the users of marketing devices 108 on which to present data comprising abstracted business logic from which marketing utility computing platform 104 generates rules for identifying customers. Marketing devices 108 may display, via display devices of marketing devices 108, the UI including one or more fillable and editable forms, drop-down menus, or the like for receipt of user input for users of marketing devices 108 to configure the business logic.

Marketing utility computing platform 104, responsive to the configuration of business logic, may process the business logic into customer rules that implement the business logic. Marketing utility computing platform 104 may process the business logic into rules configured to identify customers by customer traits. As one example, marketing utility computing platform 104 may receive business logic configured to cause the selection of customers with a credit score above 720 and a mortgage in good standing with the financial institution of system 100. Continuing this example, marketing utility computing platform 104, responsive to the receipt of the configured business logic, processes the business logic into rules configured to identify customers having customer traits associated with the credit score above 720 and a mortgage in good standing.

Marketing utility computing platform 104 may apply the rules to the customer data. Marketing utility computing platform 104 may apply the rules to and process the customer data on a regular basis (e.g., daily, weekly, monthly). Marketing utility computing platform 104 may process the customer data in response to the receipt of new customer data from corporate databases 110. In one example, corporate databases 110 are updated on a daily basis with new customer data at the end of each workday and provide updated customer data to marketing utility computing platform 102. Marketing utility computing platform 104 may process customer data in real-time as it is streamed from corporate databases 110 to data analytics system 102 and provided to marketing utility computing platform 104.

Marketing utility computing platform 104, responsive to the receipt of customer data, applies the rules to the customer data received from corporate databases 110. Marketing utility computing platform 104 may apply the rules using parallel processing (i.e., splitting the customer data into subsets and simultaneously processing the subsets). Additionally, marketing utility computing platform 104 may apply the rules using orders of operations configured by a user or marketing utility computing platform 104 may determine the order of operations for applying the rules to the customer data.

Marketing utility computing platform 104 may output a report of customer identifiers that lists customers by their associated identifier and whether each customer represented by their associated customer identifier has the one or more traits. For example, marketing utility computing platform 104 may output a report comprising a list of customers organized by customer identifier and indicators of whether the individual customers have the trait sought. In some examples, the indicators may comprise binary indicators, e.g., Y/N or 1/0, to indicate whether a given customer does or does not have the traits included on the report. Marketing utility computing platform 104 may provide the report to marketing devices 108 for display to users of marketing devices 108.

Marketing utility computing platform 104 may provide a number of benefits and applications. For example, marketing utility computing platform 104 may decrease the length of time necessary to implement the requirements of a marketing campaign by reducing the length of time necessary to convert customer requirements into rules for identifying customers from an organization's databases. In another example, marketing utility computing platform 104 may enable faster responses to the receipt of customer data through parallel processing of customer data.

Marketing utility computing platform 104 may additionally enable easier rule creation by users of marketing devices 108. Rather than a user determining the requirements necessary to implement a marketing campaign and providing those requirements to a software team for implementation, marketing utility computing platform 104 may enable the user to instead configure the requirements themselves through a UI displayed by marketing devices 108. Marketing devices 108 may then provide the user's configuration of business logic to marketing utility computing platform 104 for implementation rather than to a software development team. Marketing utility computing platform 104 may additionally enable users to make real-time modifications to the requirements for identifying customers. In an example, the Federal Funds Rate increases and in response a user of marketing devices 108 determines that it would be beneficial for a marketing campaign to reduce a required credit score from 740 to 720. Marketing utility computing platform 104 enables a user of marketing devices 108 to modify the business logic and implement the modified requirements of the marketing campaign without requiring a software development team to recode a program for identifying customers.

Marketing utility computing platform 104 may enable more regular processing (e.g., daily) of customer data for identifying customers. For example, marketing utility computing platform 104 may enable regular processing of customer data to quickly identify new customers who may have been recently added to corporate databases 110 and customers whose attributes have recently changed (e.g., a customer turns 18 and becomes eligible for more financial products). Marketing utility computing platform 104 may enable more regular processing of customer data to improve response times to the receipt of new customer data. Marketing utility computing platform 104 may enable the more regular processing of data to ensure the most accurate list of customers for the marketing campaign on any given day.

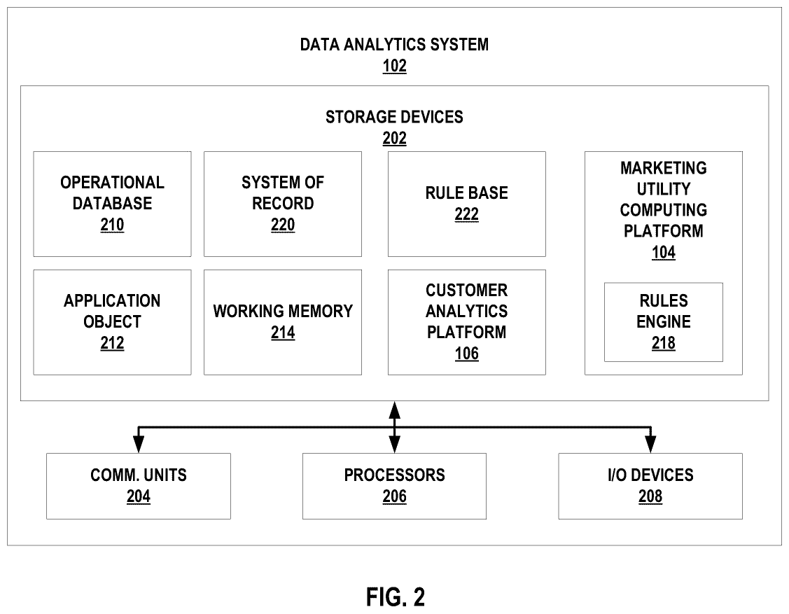

FIG. 2 is a block diagram illustrating an example data analytics system configured to execute the marketing utility computing platform from FIG. 1. Data analytics system 102 may be a single server, cluster of servers, a virtualized computing environment, distributed computing environment, and/or the like. Data analytics system 102 is illustrated as a single computing device in FIG. 2 for purposes of illustration.

In the illustrated example of FIG. 2, data analytics system 102 includes storage devices 202, communication units 204, processors 206, and input/output (I/O) devices 208. Storage devices 202 may comprise one or more storage mediums such as hard disk drives, solid state drives, tape storage, and other storage mediums. In some examples, storage devices 202 include one or more of a short-term memory or a long-term memory. Storage devices 202 may include, for example, random access memories (RAM), dynamic random-access memories (DRAM), static random-access memories (SRAM), magnetic discs, optical discs, flash memories, or forms of electrically programmable memories (EPROM) or electrically erasable and programmable memories (EEPROM). In some examples, storage devices 202 are used to store program instructions for execution by processors 206. Storage devices 202 may be used by software or applications running on data analytics system 102 (e.g., customer analytics platform 106 and marketing utility computing platform 104) to temporarily store information during program execution. In the example of FIG. 2, storage devices 202 may include operational database 210, application object 212, working memory 214, system of record 220, and rule base 222.

Communication units 204 may include one or more types of communication units. Communication units 204 may be network interfaces (such as Ethernet interfaces, optical transceivers, radio frequency (RF) transceivers, Wi-Fi or Bluetooth radios, or the like), telephony interfaces, or any other type of devices that can send and receive information. Data analytics system 102 may utilize communication units 204 and/or application programming interfaces (APIs) to communicate with other systems or devices via one or more connections or networks, e.g., marketing devices 108 and/or corporate databased 110 of FIG. 1.

Processors 206, in one example, may comprise one or more processors that are configured to implement functionality and/or process instructions for execution within data analytics system 102. For example, processors 206 may be capable of processing instructions stored by storage devices 202. Processors 206 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

I/O devices 208 may include one or more input devices and one or more output devices. I/O devices 222 may include input devices such as keyboards, mice, touchscreens, microphones, and other input devices. I/O devices 22 may include output devices such as display devices, speakers, and other output devices. I/O devices 208 may receive input or generate output in the form of text, audio, video, or images.

Data analytics system 102 may receive configurations of business logic via communication units 204 (e.g., from marketing devices 108 as illustrated in FIG. 1). Data analytics system 102 may provide the configured business logic to marketing utility computing platform 104 for processing into rules. Marketing utility computing platform 104 may process the business logic using rules engine 218 into rules for identifying customer traits from customer data. Responsive to the generation of the rules, marketing utility computing platform 104 may store the rules in rules base 222. Rules base 222 may include a plurality of rules used to identify customers based on customer traits. For example, rules base 222 may store rules used to identify customer traits such as rules that identify customer traits associated with customer credit score, whether or not the customer has a mortgage in good standing, whether the customer is a certain age, and other customer traits.

In some examples, customer analytics computing platform 104 may facilitate modifications to existing rules in rule base 222. For example, customer analytics computing platform 104 may obtain rules from rules base 222, process them into business logic, and provide the business logic to other computing devices such as marketing devices 108 as illustrated in FIG. 1 for configuration of the rules.

Upon receipt of a particular marketing campaign or other request, marketing utility platform 104 may log the rules selected to be used for identifying customers for the particular marketing campaign or other request in application object 212. Application object 212 may be configured by marketing utility computing platform 104 to define the schema of rules that are to be used in identifying customers.

Marketing utility computing platform 104, responsive to the logging of rules, may request customer data to identify customers that have the traits defined by the logged rules. Responsive to the request for customer data, customer analytics platform 106 may obtain customer data (e.g., data from corporate databases 110 as illustrated in FIG. 1) for marketing utility computing platform 104. Customer analytics platform 106 may preprocess the customer data and host the data in operational database 210 for use by marketing utility computing platform 104.

Marketing utility computing platform 104 may apply the rules from application object 212 to the data hosted in operational database 210. Marketing utility computing platform 104 may apply the rules using waterfall logic. In an example, marketing utility platform 104 has logged 30 rules in application object 212. Marketing utility computing platform 104 may apply the rules in an iterative fashion using waterfall logic. Marketing utility computing platform 104 may adjust the order of operation of the iterative application of the rules to the customer data in response to user configuration of the order of operations or automatically to maximize the number of customers identified. For example, marketing utility computing platform 104 may apply two rules to customer data, the first rule being that customers must be over the age of 21 and the second rule being that all customers must reside in the Commonwealth of Virginia. Marketing utility computing platform 104 may apply the first rule and the second rule in that order, record the identified customers, and then apply the second rule and then the first rule and record the identified customers. Marketing utility computing platform 104 may then combine the two sets of identified customers to maximize the number of customers identified that meet the requirements of both rules.

Marketing utility computing platform 104 may utilize working memory 214 in applying the rules to the customer data. Marketing utility computing platform 104 may store the rules and customer data currently being matched in working memory 214 while marketing utility computing platform 104 conducts the matching.

Marketing utility computing platform 104 may apply the rules to the customer data and identify which customers have the traits identified by the associated rules (e.g., a rule designed to identify customers with auto loans in good standing). Responsive to the application of the rules to customer data, marketing utility computing platform 104 may store a list of customers in system of record 220 along with indicators as to which customers have particular traits (e.g., a customer may have 4 out of the 5 traits sought). Marketing utility computing platform 104 may generate a report of the customers and whether each customer has the traits sought. Marketing utility computing platform 104 may generate a report that lists customers by customer identifier and what traits, if any, each customer has. Marketing utility computing platform 104 may provide the report to other computing devices such as marketing devices 108 as illustrated in FIG. 1.

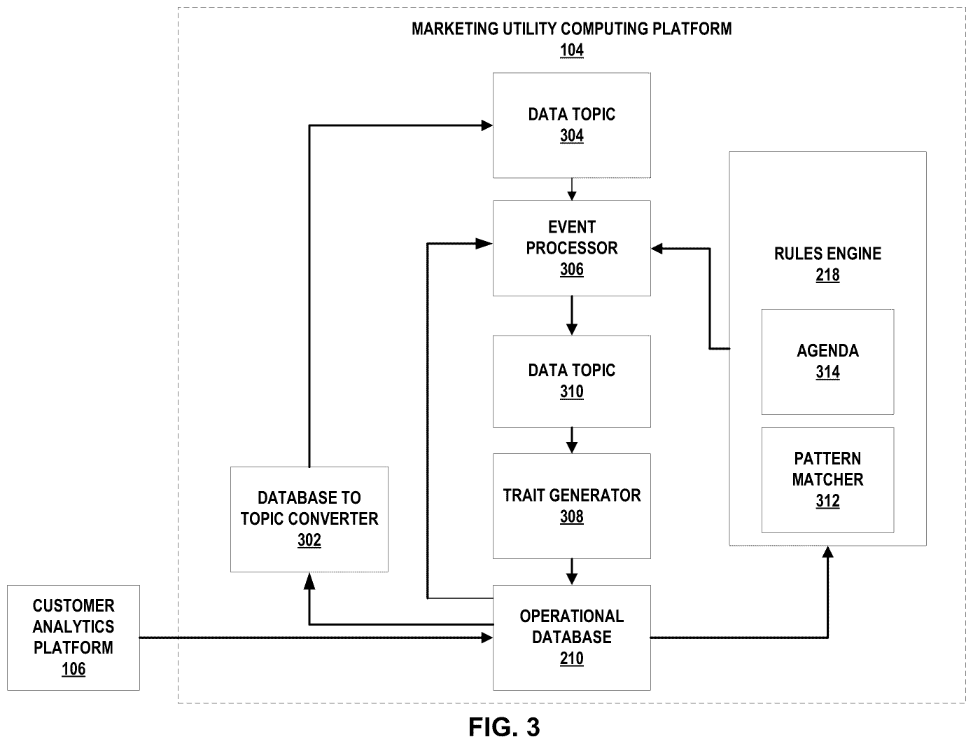

FIG. 3 is a block diagram illustrating an example of the marketing utility computing platform from FIG. 1 in greater detail. FIG. 3 includes customer analytics platform 106 and marketing utility computing platform 104. Marketing utility computing platform 104 includes operational database 210, rules engine 218, database-to-topic converter 302, data topic 304, event processor 306, trait generator 308 and data topic 310.

As discussed in earlier sections, customer analytics platform 106 may provide customer data to operational database 210. Customer analytics platform 106 may acquire customer data from one or more databases, preprocess the data, and provide the customer data to operational database 210 of marketing utility computing platform 104. Customer analytics platform 106 may preprocess the customer data to ensure it conforms to the data format used by marketing utility computing platform 104. For example, customer analytics platform 106 may acquire customer data from a variety of databases which may have differing manners of associating customer data with customer identifiers (e.g., databases storing mortgage information may have a different manner of data organization than databases storing customer credit information). Customer analytics platform 106 may process the customer data and provide the preprocessed data to marketing utility computing platform 104.

Marketing utility computing platform 104 may receive the customer data from customer analytics platform 106 and store it in operational database 210 for processing. Marketing utility computing platform 106 may receive the customer data from customer analytics platform 106 as a data stream and process the data stream in real time as it is received from customer analytics platform 106. Marketing utility computing platform 104 may additionally process the customer data in batches using parallel processing to simultaneously process batches of customer data and accelerate the processing of the customer data.

Marketing utility computing platform 104 may utilize database-to-topic converter 302 to convert and organize customer data from operational databases 210 into data topics that logically partition the customer data. The customer data may be partitioned based on data source, data type, or customer identifier. For examples, database-to-topic converter 302 may separate the customer data into two or more groups of customer data based on the customer identifiers associated with the data. In this example, each group of the two or more groups may include substantially the same number of customers, e.g., database-to-topic converter 302 may attempt to create groups with equal numbers of customers but exactly equal groups may not be possible. Marketing utility computing platform 104 may store the data topics in data topic 304.

Marketing utility computing platform 104 may process the rules and customer data through event processor 306. Event processor 306 may process the customer data and organize it into the form used by rules engine 218 to process the customer data. Event processor 306 may organize the customer data for processing either sequentially or in parallel by data topics stored in data topic 304. Event processor 306 then sends the organized customer data to rules engine 218 for processing with respect to the appropriate rules.

Event processor 306 may receive processed customer data from rules engine 218 that includes customer data of customers from which customer traits have been identified. Event processor 306 may provide the customer data processed by rules engine 218 to data topic 310. Marketing utility computing platform 104 may store the processed customer data in data topic 310.

Marketing utility computing platform 104 may publish the processed customer data to trait generator 308. Trait generator 308 may include a traits library where trait generator 308 stores customer traits associated with the rules. Trait generator 308 may generate and/or associate indicators (e.g., binary indicators such as Y/N or 1/0) with each trait for each customer identifier included in the processed customer data. Marketing utility computing platform 104, responsive to the processing of the rules and customer data, may push the processed data to operational database 210.

Rules engine 218 may process the customer data and apply the rules to identify customer traits from the customer data. Rules engine 218 may use pattern matcher 312 and agenda 314 to identify customers based on customer traits. Rules engine 218 may obtain rules and customer data from operation database 210. Rules engine 218 may provide the rules and customer data to pattern matcher 312. Pattern matcher 312 may match the rules against the customer data to identify customers from the customer data based on the traits of the customers.

Rules engine 218 may utilize agenda 314 to manage the execution order of applying the rules to the customer data. Agenda 314 may manage the execution order of the rules and determine conflict resolution for the execution order of the rules. Agenda 314 may modify the order of execution to resolve potential conflicts in the execution order of the rules. Rules engine 218, responsive to the determination of the order of execution of the rules, may process the customer data and identify customers based on customer traits. Rules engine 218 may provide the processed customer data to event processor 306.

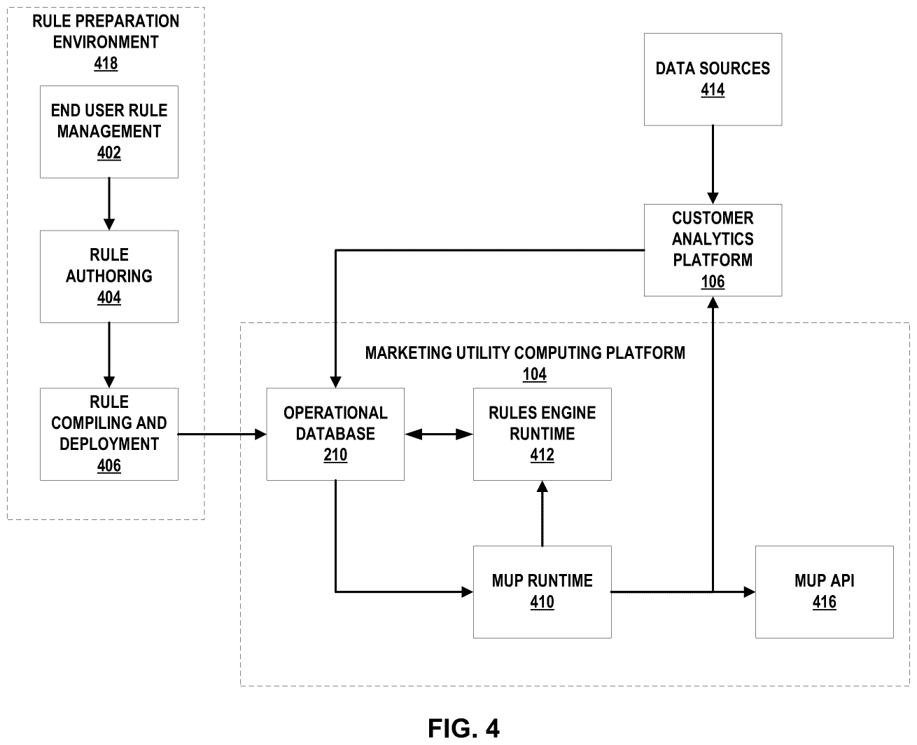

FIG. 4 is a block diagram illustrating an example operation of a marketing utility computing device 104 configured to maintain rules configured to identify customer traits and apply the rules to customer data to identify customers having the customer traits, in accordance with one or more techniques of this disclosure. FIG. 4 includes rule preparation environment 418. Rule preparation environment 418 includes end user rule management 402, rule authoring 404, and rule compiling and deployment 406. Rule preparation environment 418 illustrates an example operation of rule configuration and deployment and may occur across one or more computing systems such as marketing devices 108 and marketing utility computing platform 104 as illustrated in FIG. 1.

Rule preparation environment 418, as part of maintaining the one or more rules, may include receiving, via a user interface from a user computing device such as marketing devices 108 as illustrated in FIG. 1, a request to create a rule based on one or more requirements for a marketing campaign. Rule preparation environment 418 may create, based on the request, at least one rule to identify at least one customer trait that corresponds to the one or more requirements for the marketing campaign without requiring software development or further input from a user. Rule preparation environment 418 may maintain the rule in addition to the one or more rules.

Rule preparation environment 418, as part of maintaining the one or more rules may receive, via a user interface from a user computing device such as marketing devices 108 as illustrated in FIG. 1, a request to modify a first rule of the one or more rules. Rule preparation environment may modify, based on the request, the first rule to create a second rule without further requiring software development or further input from a user. Rule preparation environment 418 may maintain the second rule such that the first rule is replaced by the second rule within the one or more rules.

Rule preparation environment 418, as part of maintaining the one or more rules may receive, via a user interface from a user computing device, a request to remove a rule from the one or more rules. Rule preparation environment 418 may remove, based on the request, the rule from the one or more rules without requiring software development or further input from a user. Rule preparation environment 418 may maintain the one or more rules without the removed rule.

End user rule management 402 may enable rule management by users of one or more computing devices such as marketing devices 108 as illustrated in FIG. 1. End user rule management 402 may enable users to configure business logic representative of rules for identifying customers traits from customer data. End user rule management 402 generates data representative of a user interface to enable users to configure the business logic and select among existing rules using UI elements of the user interface such as fillable forms, drop-down menus, interactive UI elements (e.g., clickable buttons), interactive text entry with language recognition (e.g., a text box where a user can type traits such as “customer has mortgage”), and business programming entry (e.g., using high-level business programming languages) among other types of user interaction.

Rule authoring 404 may enable users to generate new rules through a rule authoring environment. Rule authoring 404 may enable organizations to validate new rules and business logic before the new rules are deployed for customer identification. Rule authoring 404 may enable organizations to conduct validation such as regulatory compliance, verifying functionality (i.e., ensuring the business logic and associated rule result in the desired output), and other validation and compliance verification.

Rule compiling and deployment 406 may process the user-configured business logic into rules for identifying customers. Rule compiling and deployment 406 may process the user-configured business logic into code representative of rules for identifying customers by customer traits. Rule compiling and deployment 406 may compile the code and test the code before deploying it to operational database 210.

As illustrated in FIG. 4, marketing utility computing platform 104 may include operational database 210, marketing utility platform (MUP) runtime 410, rules engine runtime 412, and MUP API 416.

Operational database 210 may receive rules deployed from rule compiling and deployment 406. Operational database 210 may provide the rules and customer data to MUP runtime 410. MUP runtime 410 may represent the processes of one or more components of marketing utility computing platform 104 such as event processor 306 and trait generator 308 as illustrated in FIG. 3. MUP runtime 410 may provide the rules and customer data to rules engine runtime 412. In addition, MUP runtime 410 may provide the results of the customer identification to customer analytics platform 106 and/or make the results of the customer identified available to MUP API 416. MUP API 416 may enable other applications to directly access the customer identification results of marketing utility computing platform 104 via one or more APIs.

Rules engine runtime 412 may apply the rules to the customer data and identify customers based on customer traits. Rules engine runtime 412 may apply the rules in batches and using parallel processing of batches of customer data. As indicated by the double arrow, rules engine runtime 412 may process the data from operational database 210 in multiple stages and utilize one or more loops in processing the customer data.

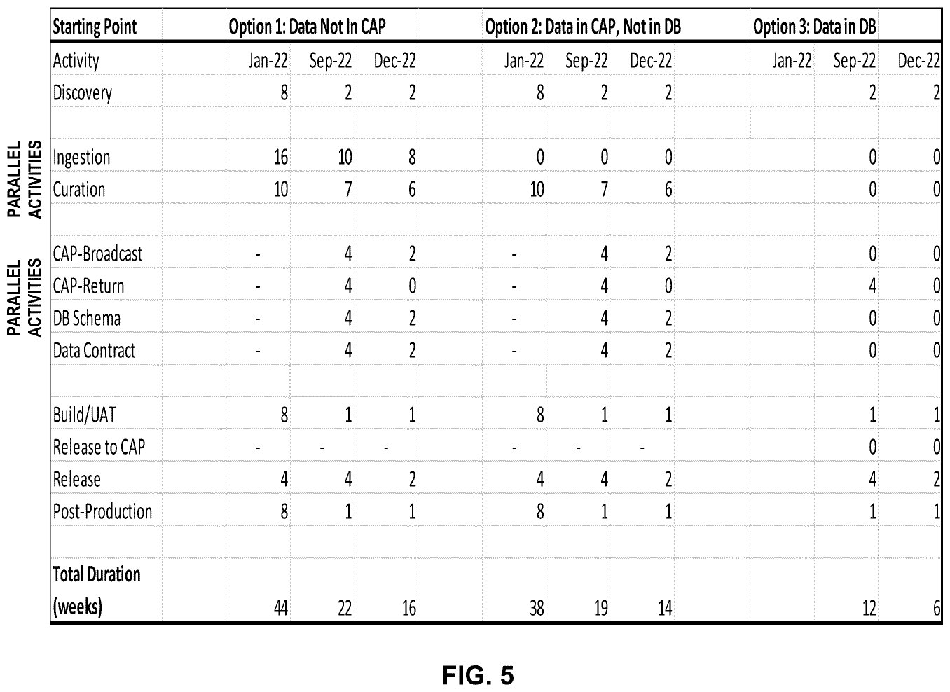

FIG. 5 is a chart illustrating example time durations from determination of business logic for a marketing campaign to implementation of the marketing campaign in different scenarios. FIG. 5 illustrates example time durations for steps such as ingestion of data, curation of customer data, customer analytics platform processes, determining database schema, building and releasing of rules, and post-production. FIG. 5 illustrates the reduced turnaround times of the marketing utility computing platform in comparison to traditional marketing campaign development and deployment.

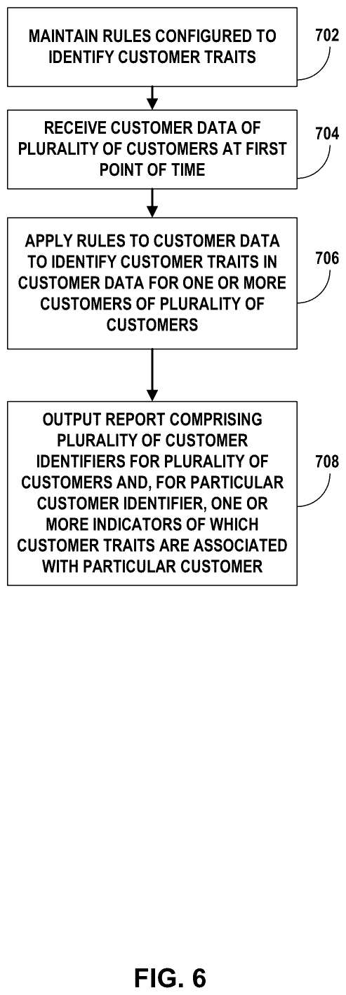

FIG. 6 is a flowchart illustrating an example operation of a marketing utility computing platform, in accordance with one or more techniques of this disclosure. The example operation of FIG. 6 is described with respect to marketing utility computing platform 104 of FIGS. 3 and 4.

Marketing utility computing platform 104 may maintain rules configured to identify customer traits (702). Marketing utility computing platform 104 may maintain rules that are derived from user-configured business logic. Marketing utility computing platform 104, responsive to the receipt of user-configured business logic, may process the business logic into the rules maintained by marketing utility computing platform 104.

Marketing utility computing platform 104 may receive customer data of a plurality of customers at a first point in time (704). Marketing utility computing platform 104 may receive customer data from one or more sources such as databases within an organization's internal network. Marketing utility computing platform 104 may receive a variety of customer data such as mortgage data, credit history, banking data, customer demographics, and other types of customer data. Marketing utility computing platform 104 may receive the customer data as a data stream from one or more databases. Additionally, Marketing utility computing platform may receive customer data on a regular basis such as daily, biweekly, and weekly. Marketing utility computing platform may determine whether received customer data is an update to previously received customer data and determine the delta between the newly received customer data and previously received customer data. Marketing utility computing platform 104 may purge previously received customer data at predetermined intervals.

Marketing utility computing platform 104 may apply the rules to customer data to identify customer traits in customer data for one or more customers of the plurality of customers (706). Marketing utility computing platform 104 may apply the rules using a rules engine 218 that matches the rules to customer traits and ensures that there are no conflicts between the rules. Marketing utility computing platform 104 may apply the rules to customer data using parallel processing and waterfall logic. In addition, Marketing utility computing platform 104 may apply the rules to the customer data in real-time as the customer data is received by the marketing utility computing platform.

Responsive to the processing of the customer data, marketing utility computing platform 104 may output a report comprising a plurality of customer identifiers for the plurality of customers and, for a particular customer identifier, one or more indicators of which customer traits are associated with the particular customer (708). Marketing utility computing platform 104 may output the report to other computing devices such as marketing devices used by marketing teams or via one or more APIs to other computing devices. Marketing utility computing platform 104 may output the report as data for a UI.

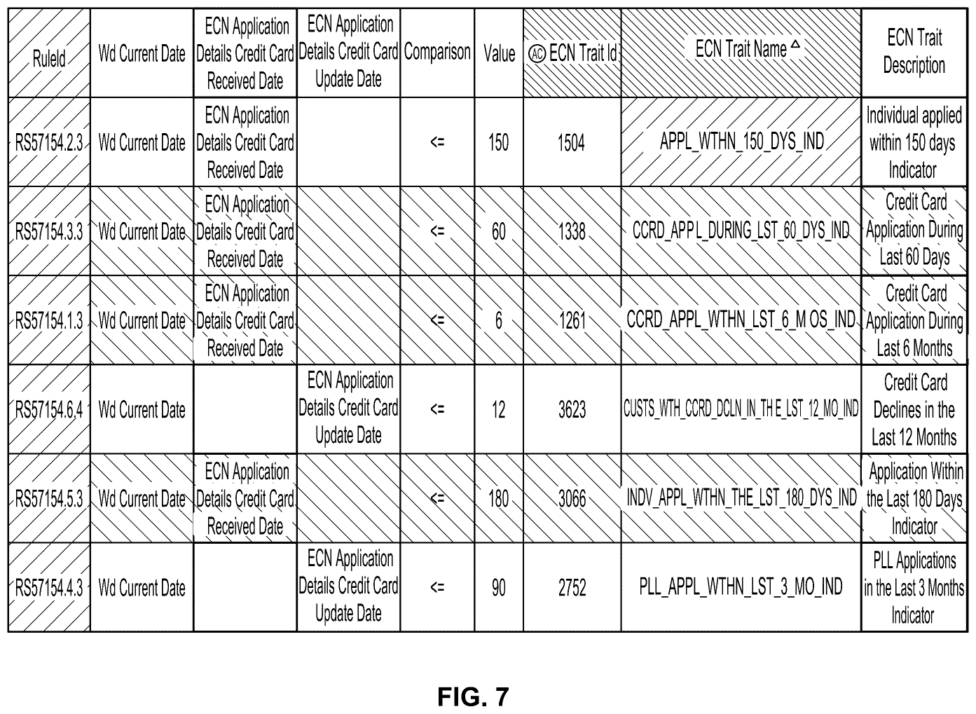

FIG. 7 is an example user interface of the marketing utility computing platform illustrating the authoring of rules. The illustrated user interface includes a list of rules organized by rule id. The illustrated user interface also includes several example characteristics of the rules such as Enterprise Customer Number (ECN) trait ID, ECN trait name, and ECN trait description (e.g., a rule with the name “CCRD_APPL_DURING_LST_60_DYS_IND” and trait ID1338 corresponds to identifying customers who have applied for a credit card within the last 60 days). The marketing utility computing platform may enable users to configure the rules using a user interface such as the one illustrated by FIG. 7.

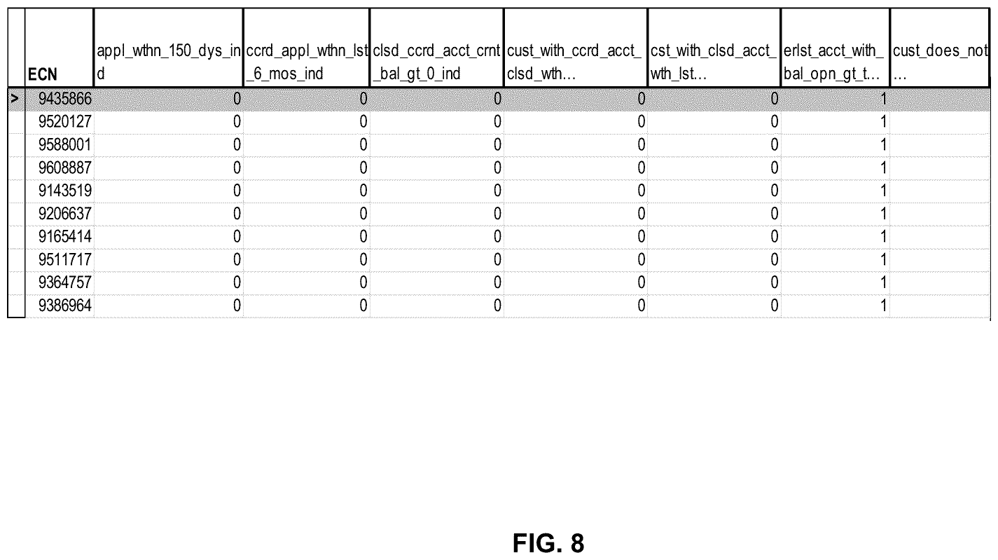

FIG. 8 is an example user interface of the marketing utility computing platform illustrating an example output of customer identifiers (i.e., ECNs) and associated traits. The illustrated user interface includes a list of ECNs with binary indicators of whether each customer associated with their ECN has a particular trait. For example, the customer represented by ECN 9511717 does not have the trait “appl_wthn_150_dys_ind” as represented by the 0 in the respective field and has the trait “erlst_acct_with_bal_opn_gt_t” as represented by the 1 in the respective field. The marketing utility computing platform may output data consistent with a user interface such as the one illustrated in FIG. 8 for users of the marketing utility computing platform to view the output of the marketing utility computing platform.

Various examples have been described. These and other examples are within the scope of the following claims. For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., corporate databases 110, data analytics system 102, marketing devices 108, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each depict at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses. Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
maintaining, by a computing system, one or more rules configured to identify one or more customer traits from customer data;
receiving, by the computing system, customer data of a plurality of customers at a first point of time;
applying, by the computing system, the one or more rules to the customer data to identify the one or more customer traits in the customer data for one or more customers of the plurality of customers; and
outputting, by the computing system, a report comprising a plurality of customer identifiers for the plurality of customers and, for a particular customer identifier for a particular customer, one or more indicators of which customer traits are associated with the particular customer.

2. The method of claim 1, wherein maintaining the one or more rules comprises:
receiving, via a user interface from a user computing device, a request to create a rule based on one or more requirements for a marketing campaign;
creating, based on the request, at least one rule to identify at least one customer trait that corresponds to the one or more requirements for the marketing campaign without requiring software development or further input from a user; and
maintaining the rule in addition to the one or more rules.

3. The method of claim 1, wherein maintaining the one or more rules comprises:
receiving, via a user interface from a user computing device, a request to modify a first rule of the one or more rules;
modifying, based on the request, the first rule to create a second rule without further requiring software development or further input from a user; and
maintaining the second rule such that the first rule is replaced by the second rule within the one or more rules.

4. The method of claim 1, wherein maintaining the one or more rules comprises:
receiving, via a user interface from a user computing device, a request to remove a rule from the one or more rules;
removing, based on the request, the rule from the one or more rules without requiring software development or further input from a user; and
maintaining the one or more rules without the removed rule.

5. The method of claim 1, wherein receiving the customer data further comprises receiving the customer data of the plurality of customers at the first point of time as a data stream.

6. The method of claim 5, further comprising separating the customer data into two or more groups of customer data based on the plurality of customer identifiers for the plurality of customers, wherein each group of the two or more groups includes substantially a same number of customers,
wherein applying the one or more rules to the customer data comprises simultaneously applying the one or more rules to each group of the two or more groups of customer data using parallel processing.

7. The method of claim 1, wherein receiving the customer data further comprises receiving the customer data of the plurality of customers at the first point of time from at least one of a non-relational database, a customer analytics platform, or corporate data records.

8. The method of claim 1, wherein receiving the customer data comprises receiving the customer data at least daily.

9. The method of claim 1, wherein receiving the customer data comprises receiving a delta of a first set of customer data at the first point in time compared to a second set of customer data at a second point in time that is prior to the first point in time.

10. The method of claim 1, wherein applying the one or more rules to the customer data comprises:
obtaining an order of operations for applying the one more rules to the current customer data; and
applying the one or more rules to the current customer data in accordance with the order of operations.

11. The method of claim 1, wherein the customer data comprises a first set of customer data of the plurality of customers, and the report comprises a first report, the method further comprising:
receiving, by the computing system, a second set of customer data of the plurality of customers at a second point in time that is subsequent to the first point in time; applying, by the computing system, the one or more rules to the second set of customer data; and
outputting, by the computing system, a second report comprising the plurality of customer identifiers for the plurality of customers and, for the particular customer identifier for the particular customer, at least one indicator of a customer trait associated with the particular customer that is different than of the one or more indicators included in the first report.

12. The method of claim 1, further comprising:
receiving, by the computing system, one or more requirements for a marketing campaign; and
selecting, by the computing device, a set of rules from the one or more rules, wherein the set of rules identify a set of customer traits that corresponds to the one or more requirements for the marketing campaign,
wherein applying the one or more rules to the customer data comprises applying, by the computing device, the set of rules to the customer data, and
wherein outputting the report comprises outputting, by the computing device, the report comprising the plurality of customer identifiers for the plurality of customers and, for the particular customer identifier for the particular customer, one or more indicators of which customer traits of the set of customer traits are associated with the particular customer.

13. The method of claim 1, further comprising:
generating, by the computing system, data representative of a user interface for display on a user computing device, the user interface including the one or more rules; and
receiving, by the computing system and via the user interface from the user computing device, a selection of at least one rule of the one or more rules to identify at least one customer trait that corresponds to at least one requirement for a marketing campaign.

14. A computing system comprising:
a memory; and
one or more programmable processors in communication with the memory and configured to:
maintain one or more rules configured to identify one or more customer traits from customer data;
receive customer data of a plurality of customers at a first point of time;
apply the one or more rules to the customer data to identify the one or more customer traits in the customer data for one or more customers of the plurality of customers; and
output a report comprising a plurality of customer identifiers for the plurality of customers and, for a particular customer identifier for a particular customer, one or more indicators of which customer traits are associated with the particular customer.

15. The computing system of claim 14, wherein to receive the customer data, the one or more programmable processors are configured to receive the customer data of the plurality of customers at the first point of time as a data stream.

16. The computing system of claim 14 wherein the one or more programmable processors are further configured to separate the customer data into two or more groups of customer data based on the plurality of customer identifiers for the plurality of customers, wherein each group of the two or more groups includes substantially a same number of customers,
wherein to apply the one or more rules to the customer data, the one or more programmable processors are configured to simultaneously apply the one or more rules to each group of the two or more groups of customer data using parallel processing.

17. The computing system of claim 14, wherein to receive the customer data, the one or more programmable processors are configured to receive a delta of a first set of customer data at the first point in time compared to a second set of customer data at a second point in time that is prior to the first point in time.

18. The computing system of claim 14, wherein the customer data comprises a first set of customer data of the plurality of customers and the report comprises a first report, and wherein the one or more programmable processors further configured to:
receive a second set of customer data of the plurality of customers at a second point in time that is subsequent to the first point in time;
apply the one or more rules to the second set of customer data; and
output a second report comprising the plurality of customer identifiers for the plurality of customers and, for the particular customer identifier for the particular customer, at least one indicator of a customer trait associated with the particular customer that is different than of the one or more indicators included in the first report.

19. The computing system of claim 14, wherein the one or more programmable processors are further configured to:
receive one or more requirements for a marketing campaign; and
select a set of rules from the one or more rules, wherein the set of rules identify a set of customer traits that corresponds to the one or more requirements for the marketing campaign,
wherein to apply the one or more rules to the customer data, the one or more programmable processors are configured to apply the set of rules to the customer data, and
wherein to output the report, the one or more programmable processors are configured to output the report comprising the plurality of customer identifiers for the plurality of customers and, for the particular customer identifier for the particular customer, one or more indicators of which customer traits of the set of customer traits are associated with the particular customer.

20. A non-transitory computer readable medium comprising instructions that, when executed, cause one or more processors to:
maintain one or more rules configured to identify one or more customer traits from customer data;
receive customer data of a plurality of customers at a first point of time;
apply the one or more rules to the customer data to identify the one or more customer traits in the customer data for one or more customers of the plurality of customers; and
output a report comprising a plurality of customer identifiers for the plurality of customers and, for a particular customer identifier for a particular customer, one or more indicators of which customer traits are associated with the particular customer.
